(19) United States
(12) Patent Application Publication
(10) Pub. No.: US 2010/0177756 A1
(43) Pub. Date: Jul. 15, 2010

(54) ASSOCIATION METHOD IN WIRELESS LAN SYSTEM USING MULTIPLE CHANNELS

(75) Inventors: Jeeyon CHOI, Daejeon (KR); Yun-Joo Kim, Gyeonggi-do (KR); Sok-Kyu Lee, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-city (KR)

(21) Appl. No.: 12/687,773

(22) Filed: Jan. 14, 2010

(30) Foreign Application Priority Data
Jan. 14, 2009 (KR) 10-2009-0003000
Dec. 28, 2009 (KR) 10-2009-0132150

(51) Int. Cl. H04W 40/00

(52) U.S. Cl. 370/338

(57) ABSTRACT

An association method in a wireless LAN system using multiple channels includes: broadcasting a beacon frame including first channel information which is information on first available frequency channels of an access point; receiving an association request frame from a wireless station having received the beacon frame, the association request frame including the second channel information which is information on second available frequency channels of the wireless station among the first available frequency channels; and transmitting an association response frame to the wireless station, the association response frame including third channel information which is information on frequency channel allocated to the wireless station.

### CROSS-REFERENCE(S) TO RELATED APPLICATIONS

The present application claims priority of Korean Patent Application Nos. 10-2009-0003000 and 10-2009-0132150, filed on Jan. 14, 2009, and Dec. 28, 2009 respectively, which are incorporated herein by reference in their entirety.

### BACKGROUND OF THE INVENTION

1. Field of the Invention

Exemplary embodiments of the present invention relate to an association method in a wireless LAN system using multiple channels; and, more particularly, to a method for associating an access point and a wireless station in a wireless LAN system using multiple channels.

2. Description of Related Art

Internet users have rapidly increased, and in particular, wireless LAN Internet users are increasing. A wireless LAN service is a service which provides an existing short-range wired communication service, i.e., a wired LAN service, by using a wireless medium as a data transmission medium. The Institute of Electrical and Electronics Engineers (IEEE) 802.11 Infrastructure scheme has been widely used as a wireless communication method.

A wireless LAN service enables a wireless station (STA), such as a notebook computer or a personal digital assistant (PDA), to receive a variety of services, e.g., a wireless Internet service, by using an access point which functions as a wired/wireless gateway. Specifically, a medium access control (MAC) protocol of a wireless LAN defined in the IEEE 802.11 basically supports a Basic Service Set (BSS) constituted by a wireless station and an access point which functions as an association point of a distributed system. The access point performs a function similar to a LAN hub. A single access point may provide a service to wireless stations placed in a preset service area. The service area refers to an area where the access point can provide a service to the wireless stations.

FIG. 1 illustrates a typical wireless LAN system.

Referring to FIG. 1, an access point 100 and a plurality of wireless stations 101 to 104 transmit/receive data through a single channel CH_1. That is, the respective wireless stations 101 to 104 are associated with the access point through the single channel CH_1 at a different time. Thus, the plurality of wireless stations 101 to 104 can neither receive data from the access point at the same time nor transmit data to the access point at the same time.

Recently, there is a growing need for increasing data throughput provided in a single BSS, i.e., a wireless LAN system, as wireless LAN users are rapidly increasing. To this end, much study has been conducted on systems which provide a wireless LAN service through multiple channels.

### SUMMARY OF THE INVENTION

An embodiment of the present invention is directed to a method for associating an access point and a wireless station in a wireless LAN system using multiple channels.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an association method in a wireless LAN system using multiple channels includes: broadcasting a beacon frame including first channel information which is information on first available frequency channels of an access point; receiving an association request frame from a wireless station having received the beacon frame, the association request frame including the second channel information which is information on second available frequency channels of the wireless station among the first available frequency channels; and transmitting an association response frame to the wireless station, the association response frame including third channel information which is information on frequency channel allocated to the wireless station.

In accordance with another embodiment of the present invention, an association method in a wireless LAN system using multiple channels includes: receiving a beacon frame from an access point, the beacon frame including first channel information which is information on first available frequency channels of the access point; transmitting an association request frame to the access point, the association request frame including second channel information which is information on second available frequency channels of a wireless station among the first available frequency channels; and receiving an association response frame from the access point, the association response frame including third channel information which is information on frequency channel allocated to the wireless station among the second available frequency channels.

In accordance with another embodiment of the present invention, an association method in a wireless LAN system using multiple channels includes: transmitting a probe response frame to a wireless station in response to a probe request frame of the wireless station, the probe response frame including first channel information which is information on first available frequency channels of an access point; receiving an association request frame from the wireless station, the association request frame including second channel information which is information on second available frequency channels of the wireless station among the first available frequency channels; and transmitting an association response frame to the wireless station, the association response frame including third channel information on frequency channel allocated to the wireless station among the second available frequency channels.

In accordance with another embodiment of the present invention, an association method in a wireless LAN system using multiple antennas includes: transmitting a probe request frame to an access point, the probe request frame including request information on first available frequency channels of the access point; receiving a probe response frame from the access point, the probe response frame including first channel information which is information on the first available frequency channels; transmitting an association request frame to the access point, the association request frame including second channel information which is information on second available frequency channels of a wireless station among the first available frequency channels; and receiving an association response frame from the access point, the association response frame including third channel information which is information on frequency channel allocated to the wireless station among the second available frequency channels.

### BRIEF DESCRIPTION OF THE DRAWINGS

FIG. 1 illustrates a typical wireless LAN system.

FIG. 2 illustrates a method for associating an access point and a wireless station in the wireless LAN system of FIG. 1.

FIG. 3 illustrates a wireless LAN system using multiple channels in accordance with an embodiment of the present invention.

FIG. 4 illustrates an association method in a wireless LAN system using multiple channels in accordance with an embodiment of the present invention.

FIG. 5 illustrates an association method in a wireless LAN system using multiple channels in accordance with another embodiment of the present invention.

FIG. 6 illustrates an association method in a wireless LAN system using multiple channels in accordance with a specific embodiment of the present invention.

FIG. 7 illustrates an association method in a wireless LAN system using multiple channels in accordance with another specific embodiment of the present invention.

FIG. 8 illustrates an association method in a wireless LAN system using multiple channels in accordance with another embodiment of the present invention.

FIG. 9 illustrates an association method in a wireless LAN system using multiple channels in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In a wireless LAN system, a wireless station placed within an arbitrary service area finds an associatable access point through a scan process. The scan process may be roughly classified into an active scan process and a passive scan process.

According to the passive scan process, the access point periodically transmits a beacon frame, and the wireless station receives the beacon frame and finds the access point. Subsequently, the wireless station transmits an association request frame to the access frame, and receives an association response frame from the access point. In such a manner, the association between the wireless station and the access point is achieved.

On the other hand, according to the active scan process, the wireless station transmits a probe request frame to the access point, and the wireless station receives a probe response frame from the access point and finds the access point.

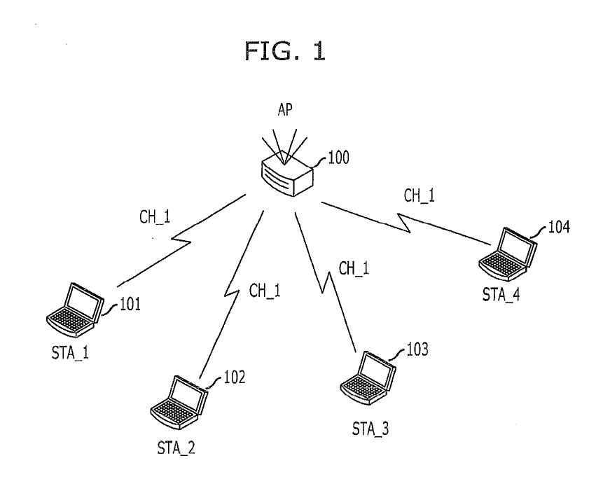

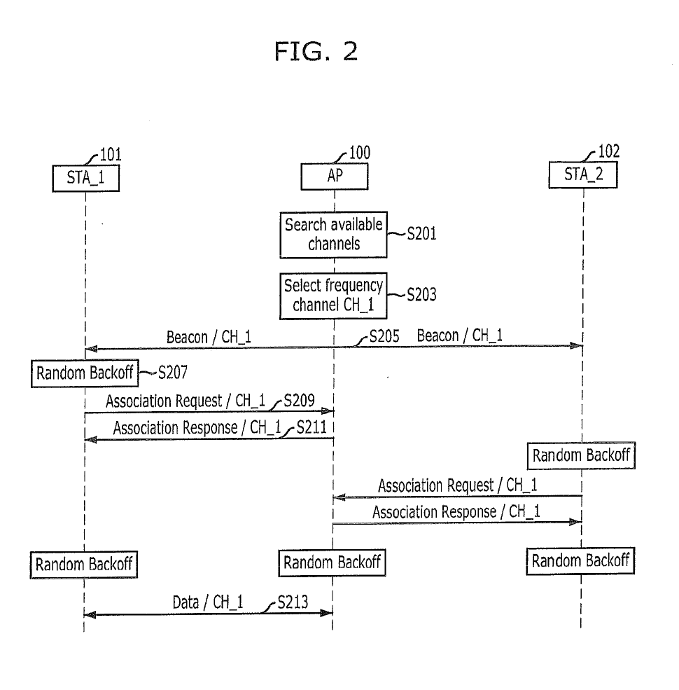

FIG. 2 illustrates a method for associating an access point and a wireless station in the wireless LAN system of FIG. 1. An association method based on a passive scan scheme will be described below with reference to FIG. 2.

The access point 100 constitutes a BSS, and searches usable channels, i.e., available frequency channels, at step S201, and selects a frequency channel CH_1 which does not overlap neighboring BSSs at step S203. The access point 100 periodically transmits a beacon frame through the selected frequency channel CH_1 at step S205.

A first wireless station 101 which receives the beacon frame performs a random backoff in order for association with the access point 100 at step S207, and transmits an association request frame to the access point 100 at step S209. In this case, the first wireless station 101 transmits the association request frame through the frequency channel CH_1 which has been used to transmit the beacon frame. The random backoff is a method of reducing data transmission collision between wireless stations and enabling the wireless station to acquire transmission opportunity, and the wireless station in the wireless LAN system acquires the transmission opportunity through the random backoff.

When the first wireless station 101 has no special disqualification, the access point 100 which receives the association request frame from the first wireless station 101 transmits an association response frame through the frequency channel CH_1 to the wireless station 101 in order to permit the association of the first wireless station 101 at step S211. In this manner, the association between the first wireless station 101 and the access point 100 is achieved. Subsequently, the first wireless station 101 and the access point 100 perform a random backoff in accordance with a Carrier Sense Multiple Access with Collision Avoidance (CSMA/CA) protocol and transmit/receive data at step S213.

When a second wireless station 102 acquires transmission opportunity through a random backoff, like the first wireless station 101, the second wireless station 102 transmits an association request frame to the access point 100 and receives an association response frame from the access point 100. In such a manner, the association between the access point 100 and the second wireless station 102 is achieved.

The above-described association method based on the passive scan scheme and the above-described association method based on the active scan scheme are related to the wireless LAN systems using a single channel. In wireless LAN systems using multiple channels, however, an association method for multiple channels is required.

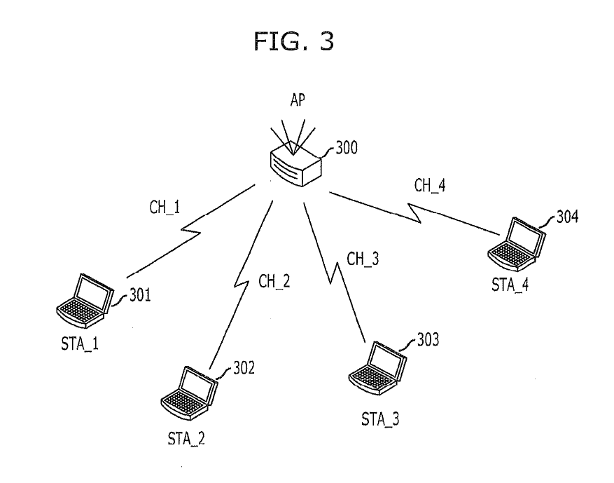

FIG. 3 illustrates a wireless LAN system using multiple channels in accordance with an embodiment of the present invention. A case where four wireless stations 301 to 304 are included in the wireless LAN system and four channels CH_1 to CH_4 are used will be described as an embodiment of the present invention with reference to FIG. 3, but the number of the wireless station and the multiple channels may be changed according to system design.

Referring to FIG. 3, the wireless LAN system in accordance with the embodiment of the present invention includes an access point 300 and a plurality of wireless stations 301 to 304. The access point 300 and the plurality of wireless stations 301 to 304 transmit/receive data through different channels CH_1 to CH_4. Specifically, the access point 300 which can use the multiple channels CH_1 to CH_4 at the same time constitutes one BSS together with the plurality of wireless stations 301 to 304 which can use different channels.

Compared with the wireless LAN system of FIG. 2, the data throughput is improved because the wireless LAN system using the multiple channels can provide a wireless LAN service in accordance with a CSMA/CA protocol independently with respect to the respective multiple channels. That is, the access point 300 may be associated with all the wireless stations 301 to 304 through different channels CH_1 to CH_4. In the case of the wireless LAN system illustrated in FIG. 3, quadruple data throughput may be provided because the wireless LAN services can be simultaneously provided through the four frequency channels CH_1 to CH_4.

The association method of the wireless LAN system using multiple channels in accordance with the embodiment of the present invention will be described below in more detail.

The access point 300 transmits information on its available frequency channels CH_1 to CH_4 to the plurality of wireless stations 301 to 304. Each of the wireless stations 301 to 304 transmits information on frequency channel usable among the available frequency channels CH_1 to CH_4 to the access point 300. The access point 300 allocates the usable frequency channels to the respective wireless stations 301 to 304. Thus, the access point 300 and the wireless stations 301 to 304 may be associated through the channels known to each other, and transmit/receive data therebetween.

In this case, each of the wireless stations 301 to 304 may select one of the available frequency channels, and transmit the information on the usable frequency channel to the access point in accordance with a random backoff scheme. Since each of the wireless stations 301 to 304 has only to transmit information by performing a random backoff on only the selected frequency channel, the possibility of collision upon transmission of information may be remarkably reduced.

Hereinafter, the method for associating the access point and the wireless stations through different channels will be described in more detail. The passive scan scheme will be first described, and the active scan scheme will be then described.

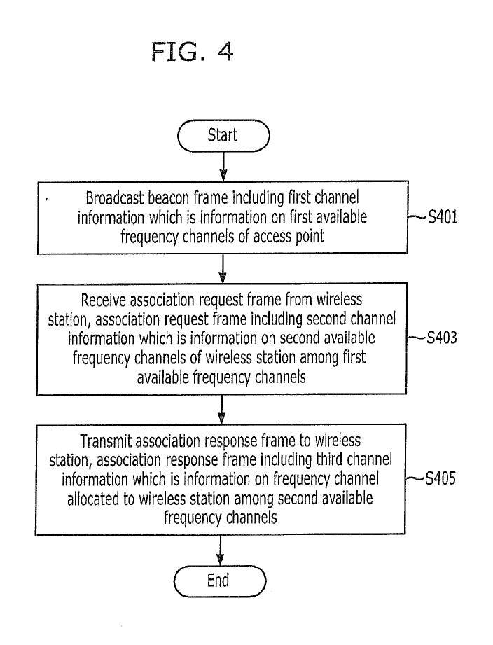

FIG. 4 illustrates an association method in a wireless LAN system using multiple channels in accordance with an embodiment of the present invention. An association method of an access point in accordance with a passive scan scheme will be described as an exemplary embodiment of the present invention.

Referring to FIG. 4, the association method in accordance with the embodiment of the present invention starts from step S401.

At step S401, an access point broadcasts a beacon frame including first channel information which is information on first available frequency channels of the access point. The access point searches usable frequency channels in a BSS which will be constituted by the access point, and selects a frequency channel which will be used among the searched usable frequency channels. That is, the first available frequency channels of the access point represent the selected frequency channels which will be used among the frequency channels searched by the access point. The access point may select and use all searched frequency channels. The access point broadcasts the beacon frame through the selected frequency channels. That is, the number of the available frequency channels of the access point may be changed according to communication environment.

At step S403, the access point receives an association request frame from a wireless station which has received the beacon frame. The association request frame includes second channel information which is information on second available frequency channels of the wireless station among the first available frequency channels. The wireless station having acquired transmission opportunity in accordance with the random backoff receives the beacon frame and transmits an association request frame to the access point in order for association with the access point. In this case, the wireless station transmits an association request frame including information on its available frequency channel. The information on the second available frequency channels of the wireless station is information on the available frequency channels of the wireless station among the first available frequency channels. When any channel among the available frequency channels of the access point does not support the wireless station, the corresponding wireless station can neither receive the beacon frame of the access point nor enter the BSS.

At step S405, the access point transmits an association response frame to the wireless station. The association response frame includes third channel information which is information on a frequency channel allocated to the wireless station among the second available frequency channels. That is, the access point allocates one of the second available frequency channels to the wireless station, and transmits the information on the allocated frequency channel to the wireless station by using the association response frame.

In this case, the access point may transmit the association response frame to the wireless station through the frequency channel used to transmit the association request frame by the wireless station. That is, the access point enables the wireless station to receive the association response frame by transmitting the association response frame through the frequency channel which is currently used by the wireless station.

Therefore, in this embodiment, the access point and the wireless station may transmit/receive data using the channel known to each other among the multiple channels. Although the case of the single wireless station has been described above with reference to FIG. 4, the method of FIG. 4 can also be applied to a wireless LAN system including a plurality of wireless stations. That is, the access point and the plurality of wireless stations may acquire transmission opportunity through a random backoff, associate each other through a known channel, and transmit/receive data through the known channel.

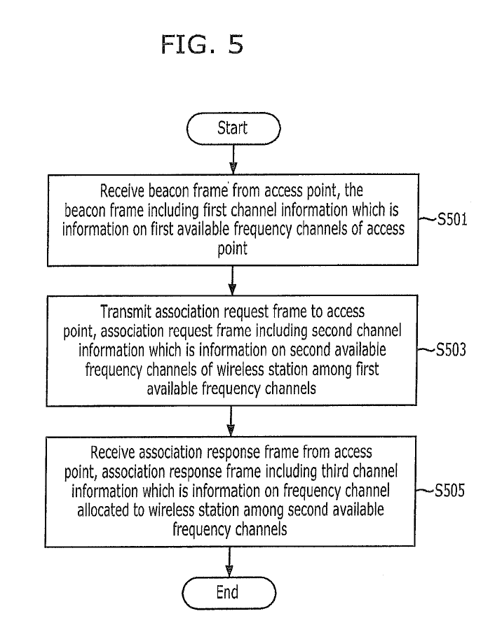

FIG. 5 illustrates an association method in a wireless LAN system using multiple channels in accordance with another embodiment of the present invention. An association method of an access point in accordance with a passive scan scheme will be described as an exemplary embodiment of the present invention.

Referring to FIG. 5, the association method in accordance with the embodiment of the present invention starts from step S501.

At step S501, a wireless station receives a beacon frame from an access point. The beacon frame includes first channel information which is information on first available frequency channels of the access point.

At step S503, the wireless station transmits an association request frame to the access point. The association request frame includes second channel information which is information on second available frequency channels of the wireless station among the first available frequency channels. In this case, the wireless station may select a single frequency channel by a preset method, and transmit the association request frame through the selected frequency channel. As described above, the access point can receive the association request frame because the second available frequency channels are included in the first available frequency channels.

Meanwhile, the second channel information may further include information on entire available frequency channels of the wireless station. The wireless station may acquire transmission opportunity through a random backoff and transmit the association request frame to the access point.

At step S505, the wireless station receives an association response frame from the access point. The association response frame includes third channel information which is information on frequency channel allocated to the wireless station among the second available frequency channels. The frequency channel allocated to the wireless station is a frequency channel allocated by the access point.

Therefore, the wireless station may transmit data to the access point or receive data from the access point through the allocated frequency channel. In case where a plurality of wireless stations are included in the wireless LAN system including the multiple channels, different frequency channels are allocated to the respective wireless stations by the access point through the method of FIG. 5, and the respective wireless stations transmit/receive data to/from the access point through the allocated different frequency channels.

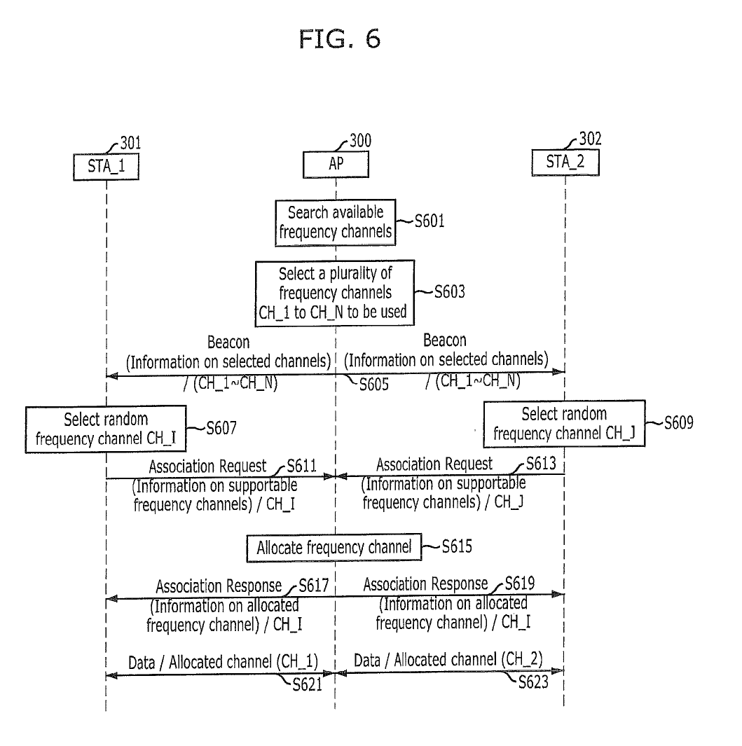

FIG. 6 illustrates an association method in a wireless LAN system using multiple channels in accordance with a specific embodiment of the present invention. A case where the two wireless stations 301 and 302 illustrated in FIG. 3 select different channels and try to associate with the access point 300 will be described below with reference to FIG. 6.

The access point 300 searches its available frequency channels at step S601, and selects multiple channels CH_1 to CH_N (where N is a natural number) to be used in a BSS which will be constituted by the access point 300 among the searched frequency channels at step S603. The access point 300 broadcasts a beacon frame through the selected frequency channel at step S605. In this case, the beacon frame includes information on frequency channels which will be used in the access point 300, i.e., the wireless LAN system.

The first and second wireless stations 301 and 302 having received the beacon frame transmit information on their available frequency channels to the access point 300. The information on the available frequency channels of the first and second wireless stations 301 and 302 are included in the available frequency channels of the access point 300. Specifically, the first wireless station 301 randomly selects one frequency channel CH_I among the available frequency channels at steps 5607 and transmits an association request frame to the access point 300 through the selected frequency channel CH_I at step S611, and the second wireless station 302 randomly selects one frequency channel CH_J among the available frequency channels at steps S609 and transmits an association request frame to the access point 300 through the selected frequency channel CH_J at step S613. In this case, the association request frames include information on the available frequency channels of the first and second wireless stations 301 and 302, and the first and second wireless stations 301 and 302 acquire transmission opportunity through a random backoff. The frequency channels CH_I and CH_J represent different frequency channels.

Meanwhile, since the frequency channels selected by the first and second wireless stations 301 and 302 in order for the transmission of the association request frames are different from each other, the association request frames transmitted by the first and second wireless stations 301 and 302 do not collide with each other, without regard to the transmission timing of the association request frames.

The access point 300 having received the association request frame allocates one frequency channel to the first wireless station 301 among the available frequency channels of the first wireless station 301, and one frequency channel to the second wireless station 302 among the available frequency channels of the second wireless station 302 at step S615. The access point 300 transmits association response frames, which are included in the information on the allocated frequency channels CH_1 and CH_2, to the first and second wireless stations 301 and 302 at steps S617 and S619. In this case, the access point 300 transmits the association response frame through the frequency channels CH_I and CH_J through which the first and second wireless stations 301 and 302 have transmitted the association request frames.

When the association is completed, the access point 300 and the first and second wireless stations 301 and 302 transmit/receive data through the allocated frequency channels CH_1 and CH_2 at steps S621 and S623.

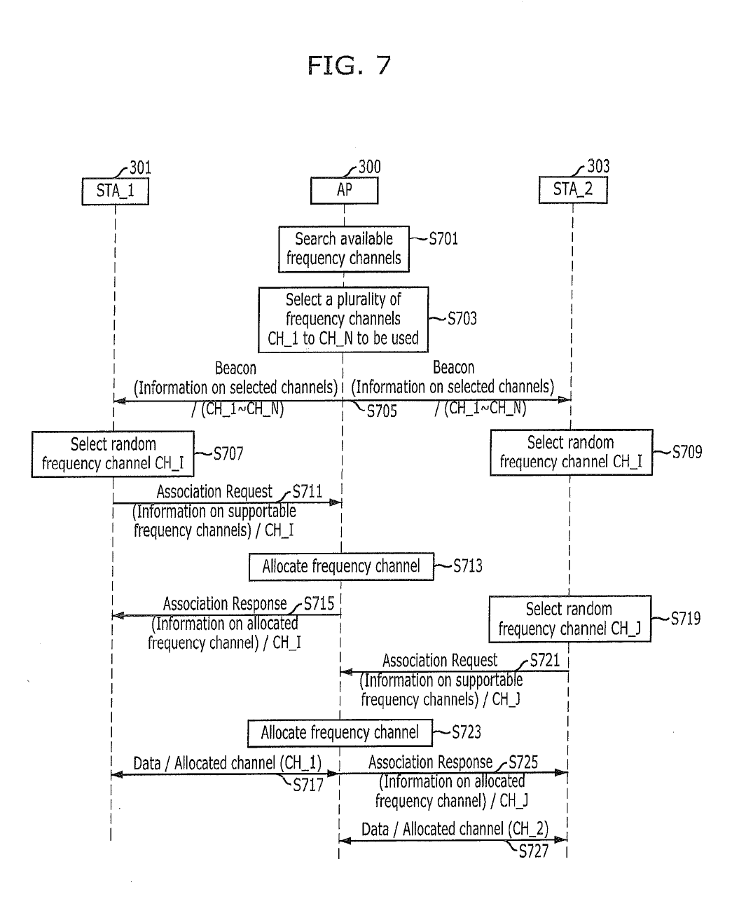

FIG. 7 illustrates an association method in a wireless LAN system using multiple channels in accordance with another specific embodiment of the present invention. A case where the two wireless stations 301 and 302 illustrated in FIG. 3 select the same frequency channels and try to associate with the access point 300 will be described below with reference to FIG. 7.

An access point 300 searches its available frequency channels at step S701, and selects multiple channels CH_1 and CH_N at step S703. The access point 300 broadcasts a beacon frame through the selected frequency channels at step S705.

First and second wireless stations 301 and 302 having received the beacon frame transmit information on their available frequency channels to the access point 300. The information on the available frequency channels is included in the available frequency channels of the access point 300. At this time, when the frequency channels selected by the first and second wireless stations 301 and 302 at steps S707 and S709 are equal to each other, one of the first and second wireless stations 301 and 302 first transmits an association request frame to the access point 300 in accordance with a random backoff scheme.

In case where the first wireless station 301 first acquires the transmission opportunity, the first wireless station 301 transmits an association request frame to the access point 300 at step S711, and receives an association response frame from the access point 300 at step S715. The association response frame includes information on the frequency channel CH_1 allocated by the access point 300 at step S713. The first wireless station 301 and the access point 300 transmit/receive data through the allocated frequency channel CH_1 at step S717.

The second wireless station 302 selects a frequency channel different from the frequency channel selected by the first wireless station 301, and acquires transmission opportunity through a random backoff at step S719. The second wireless station 302 transmits an association request frame to the access point 300 through the selected frequency channel CH_J at step S721, and receives an association response frame from the access point 300 through the selected frequency channel CH_J at step S725. The association response frame includes information on a frequency channel CH_2 allocated from the access point 300 at step S723. The second wireless station 302 and the access point 300 transmit/receive data through the allocated frequency channel CH_2.

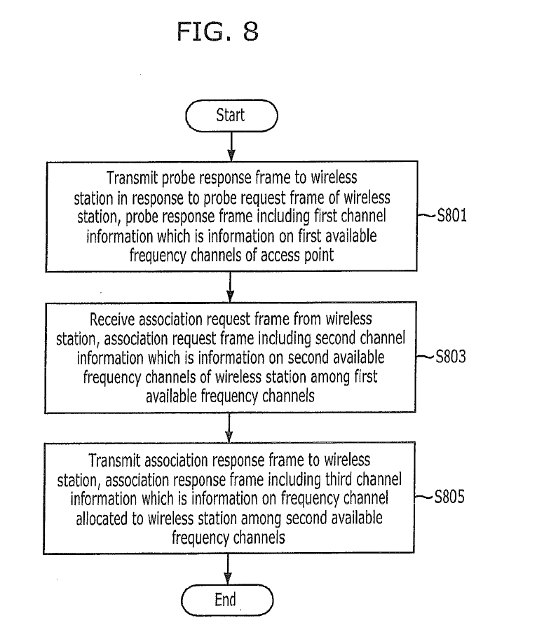

FIG. 8 illustrates an association method in a wireless LAN system using multiple channels in accordance with another embodiment of the present invention. An association method of an access point in accordance with an active scan scheme will be described as an exemplary embodiment of the present invention.

Referring to FIG. 8, the association method in accordance with the embodiment of the present invention starts from step S801.

At step S801, an access point transmits a probe response frame to a wireless station in response to a probe request frame of the wireless station. The probe response frame includes first channel information which is information on first available frequency channels of the access point. That is, the probe request frame may include request information requesting the first channel information, and the access point loads the first channel information into the probe response frame and provides the probe response frame to the wireless station in response to the request of the wireless station.

At step S803, the access point receives an association request frame from the wireless station. The association request frame includes second channel information which is information on second available frequency channels of the wireless station among the first available frequency channels. That is, the wireless station which finds the access point by receiving the probe response frame transmits the association request frame to the access point, and the access point receives the association request frame including the second channel information from the wireless station.

At step S805, the access point transmits an association response frame to the wireless station. The association response frame includes third channel information which is information on frequency channel allocated to the wireless station among the second available frequency channels. The access point allocates one of the second available frequency channels to the wireless station, and transmits information on the allocated frequency channel to the wireless station by using the association response frame.

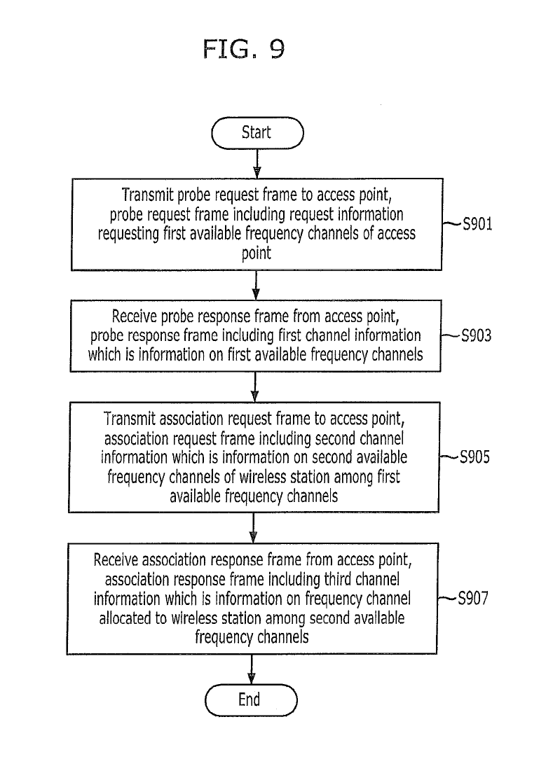

FIG. 9 illustrates an association method in a wireless LAN system using multiple channels in accordance with another embodiment of the present invention. An association method of a wireless station in accordance with an active scan scheme will be described below with reference to FIG. 9.

Referring to FIG. 9, a wireless station transmits a probe request frame to an access point. The probe request frame includes request information requesting first available frequency channels of the access point. The wireless station transmits the probe request information in order to find the access point. At this point, by inserting the request information into the probe request frame, the wireless station may receive the information on the first available frequency channels from the access point.

At step S903, the wireless station receives a probe response frame from the access point. The probe response frame includes first channel information which is information on the first available frequency channels.

At step S905, the wireless station transmits an association request frame to the access point. The association request frame includes second channel information which is information on the second available frequency channels of the wireless station among the first available frequency channels.

At step S907, the wireless station receives an association response frame from the access point. The association response frame includes third channel information which is information on frequency channel allocated to the wireless station among the second available frequency channels.

The association methods of FIGS. 8 and 9 are different from the association methods of FIGS. 4 and 5 in view of the method of finding the access point, and the method of transmitting/receiving the association request frame and the association response frame is substantially identical to the association methods of FIGS. 4 and 5. That is, the association methods of FIGS. 8 and 9 find the access point according to the transmission/reception of the probe request frame and the probe response frame. The method of transmitting/receiving the association request frame and the association response frame is substantially identical to the methods of transmitting/receiving the association request frame and the association response frame, which are described with reference to FIGS. 4 and 5.

Although the present invention has been described in view of processes, the respective steps of the association method in the wireless LAN system using multiple channels in accordance with the embodiments of the present invention can be easily understood in view of apparatuses. Therefore, the steps included in the association method in the wireless LAN system using the multiple channels in accordance with the embodiments of the present invention may be understood as the elements which are included in the access point and the wireless station using the multiple channels according to the principle of the present invention.

Specifically, the access point using multiple channels includes: a broadcasting unit configured to broadcast a beacon frame including first channel information which is information on first available frequency channels of an access point; a reception unit configured to receive an association request frame from a wireless station having received the beacon frame, the association request frame including the second channel information which is information on second available frequency channels of the wireless station among the first available frequency channels; and a transmission unit configured to transmit an association response frame to the wireless station, the association response frame including third channel information which is information on frequency channel allocated to the wireless station.

In addition, the wireless station using multiple channels includes: a first reception unit configured to receive a beacon frame from an access point, the beacon frame including first channel information which is information on first available frequency channels of the access point; a transmission unit configured to transmit an association request frame to the access point, the association request frame including second channel information which is information on second available frequency channels of a wireless station among the first available frequency channels; and a second reception unit configured to receive an association response frame from the access point, the association response frame including third channel information which is information on frequency channel allocated to the wireless station among the second available frequency channels.

Furthermore, the access point using multiple channels includes: a first transmission unit configured to transmit a probe response frame to a wireless station in response to a probe request frame of the wireless station, the probe response frame including first channel information which is information on first available frequency channels of an access point; a reception unit configured to receive an association request frame from the wireless station, the association request frame including second channel information which is information on second available frequency channels of the wireless station among the first available frequency channels; and a second transmission unit configured to transmit an association response frame to the wireless station, the association response frame including third channel information on frequency channel allocated to the wireless station among the second available frequency channels.

Moreover, the wireless station using multiple antennas includes: a first transmission unit configured to transmit a probe request frame to an access point, the probe request frame including request information on first available frequency channels of the access point; a reception unit configured to receive a probe response frame from the access point, the probe response frame including first channel information which is information on the first available frequency channels; a second transmission unit configured to transmit an association request frame to the access point, the association request frame including second channel information which is information on second available frequency channels of a wireless station among the first available frequency channels; and a second reception unit configured to receive an association response frame from the access frame, the association response frame including third channel information which is information on frequency channel allocated to the wireless station among the second available frequency channels.

In accordance with the exemplary embodiments of the present invention, the high-throughput wireless LAN service may be provided by associating the access point with the plurality of wireless stations through the multiple channels of the wireless LAN system.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. An association method in a wireless LAN system using multiple channels, the association method comprising:
broadcasting a beacon frame including first channel information which is information on first available frequency channels of an access point;
receiving an association request frame from a wireless station having received the beacon frame, the association request frame including the second channel information which is information on second available frequency channels of the wireless station among the first available frequency channels; and
transmitting an association response frame to the wireless station, the association response frame including third channel information which is information on frequency channel allocated to the wireless station.

2. The association method of claim 1, wherein the beacon frame is broadcasted through the available frequency channels of the access point.

3. The association method of claim 1, wherein the association response frame is transmitted to the wireless station through a frequency channel used to transmit the association request frame.

4. The association method of claim 1, wherein the wireless station comprises a station which acquires transmission opportunity through a random backoff.

5. An association method in a wireless LAN system using multiple channels, the association method comprising:
receiving a beacon frame from an access point, the beacon frame including first channel information which is information on first available frequency channels of the access point;
transmitting an association request frame to the access point, the association request frame including second channel information which is information on second available frequency channels of a wireless station among the first available frequency channels; and
receiving an association response frame from the access point, the association response frame including third channel information which is information on frequency channel allocated to the wireless station among the second available frequency channels.

6. The association method of claim 5, wherein the association request frame is transmitted to the access point through a frequency channel selected among the second available frequency channels.

7. The association method of claim 5, wherein the association request frame is transmitted to the access point in accordance with a random backoff scheme.

8. The association method of claim 5, wherein the second channel information further includes information on entire available frequency channels of the wireless station.

9. An association method in a wireless LAN system using multiple channels, the association method comprising:
transmitting a probe response frame to a wireless station in response to a probe request frame of the wireless station, the probe response frame including first channel information which is information on first available frequency channels of an access point;
receiving an association request frame from the wireless station, the association request frame including second channel information which is information on second available frequency channels of the wireless station among the first available frequency channels; and
transmitting an association response frame to the wireless station, the association response frame including third channel information on frequency channel allocated to the wireless station among the second available frequency channels.

10. An association method in a wireless LAN system using multiple antennas, the association method comprising:
transmitting a probe request frame to an access point, the probe request frame including request information on first available frequency channels of the access point;
receiving a probe response frame from the access point, the probe response frame including first channel information which is information on the first available frequency channels;
transmitting an association request frame to the access point, the association request frame including second channel information which is information on second available frequency channels of a wireless station among the first available frequency channels; and
receiving an association response frame from the access point, the association response frame including third channel information which is information on frequency channel allocated to the wireless station among the second available frequency channels.
